(19) United States
(12) Patent Application Publication
(10) Pub. No.: US 2020/0279238 A1
(43) Pub. Date: Sep. 3, 2020

(54) Automated Store Checkout

(71) Applicant: Eaton Intelligent Power Limited, Dublin 4 (IE)

(72) Inventors: Russell Leake, Atlanta, GA (US); Nam Chin Cho, Peachtree City, GA (US)

(21) Appl. No.: 16/785,494

(22) Filed: Feb. 7, 2020

Related U.S. Application Data
(60) Provisional application No. 62/812,746, filed on Mar. 1, 2019.

(51) Int. Cl. G06Q 20/18; G06Q 30/06

(52) U.S. Cl. CPC G06Q 20/18; G06Q 30/0633

(57) ABSTRACT

A lighting fixture for use in an automated store checkout system includes a light source, a camera, and a control unit. The control unit is configured to determine identifying attributes of a person from one or more images of the person captured by the camera. The control unit is further configured to transmit the identifying attributes to a controller and to provide a notification to the person via the light source based on a command received from the controller. The command is generated based on the identifying attributes.

### CROSS REFERENCE TO RELATED APPLICATIONS

The present application claims priority under 35 U.S.C. Section 119(e) to U.S. Provisional Patent Application No. 62/812,746, filed Mar. 1, 2019 and titled “Automated Store Checkout,” the entire content of which is incorporated herein by reference.

### TECHNICAL FIELD

The present disclosure relates generally to lighting-related solutions, and more particularly to automated store checkout operations that are integrated in lighting systems.

### BACKGROUND

Typical checkout lines at a retail store can be long, inefficient, and costly due to staff required to help with the checkout process. Many companies have come up with ways to automate this process with the help of computer vision, machine learning, mobile apps, etc. Attempts to simplify the checkout process include self-checkout counters, where customers, instead of store employees, scan their own items. However, these systems still require customers to stand in a checkout line. Further, installing new infrastructure, such as power and communication infrastructures, to automate the checkout process can be expensive and time consuming. Thus, a solution that enables automating the store checkout process cost effectively is desirable.

### SUMMARY

The present disclosure relates generally to lighting-related solutions, and more particularly to automated store checkout operations that are integrated in lighting systems. In an example embodiment, a lighting fixture for use in an automated store checkout system includes a light source, a camera, and a control unit. The control unit is configured to determine identifying attributes of a person from one or more images of the person captured by the camera. The control unit is further configured to transmit the identifying attributes to a controller and to provide a notification to the person via the light source based on a command received from the controller. The command is generated based on the identifying attributes.

In another example embodiment, an automated store checkout system includes a lighting fixture configured to transmit identifying attributes of a person, where the identifying attributes are determined by the lighting fixture based on one or more images of the person captured by a camera. The system further includes a controller configured to receive the identifying attributes of the person from the lighting fixture. The controller is further configured to record information related to one or more items removed by the person from a shelf unit at least based on information transmitted by the shelf unit and the identifying attributes of the person. The information is recorded in association with the person.

In another example embodiment, an automated store checkout method includes capturing, by a camera of a lighting fixture, one or more images of a person and determining, by a control unit of the lighting fixture, identifying attributes of the person from the one or more images of the person. The method further includes transmitting, by the control unit of the lighting fixture, identifying attributes to a central controller and recording, by a central controller, items removed from a shelf unit by the person based on the identifying attributes of the person received from a second lighting fixture and customer activity information transmitted by the shelf unit. The second lighting fixture is associated with the shelf unit.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates an automated store checkout system according to an example embodiment;

FIG. 2 illustrates a block diagram of a lighting fixture used in the automated store checkout system of FIG. 1 according to an example embodiment;

FIG. 3 illustrates an automated store checkout system according to another example embodiment;

FIG. 4 illustrates an automated store checkout system according to another example embodiment; and

FIG. 5 illustrates a block diagram of a lighting fixture with external cameras used in the automated store checkout system of FIG. 4 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different figures may designate like or corresponding, but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

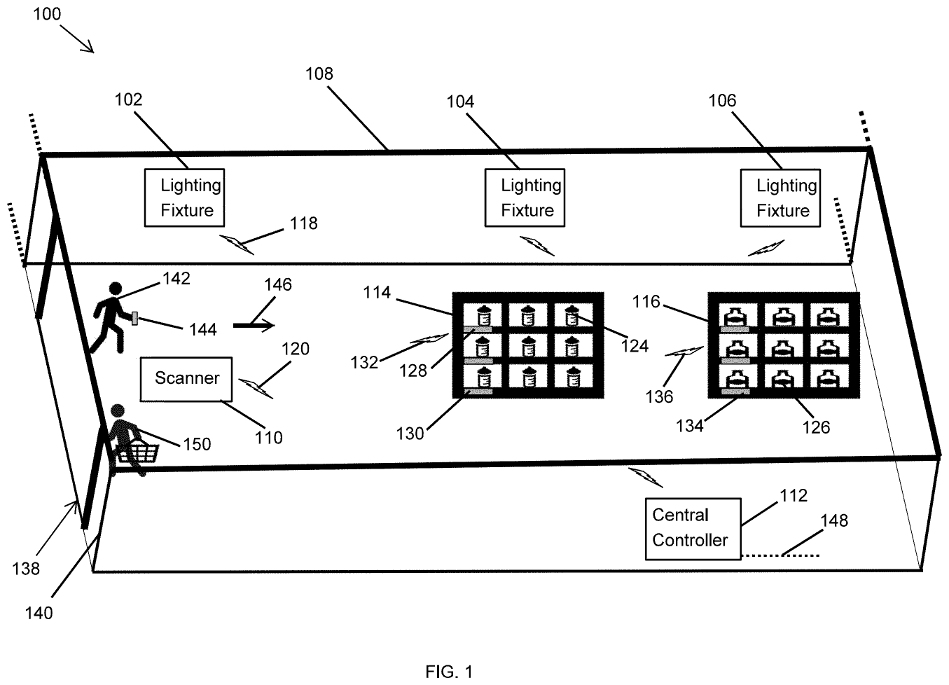

Turning now to the figures, example embodiments are described. FIG. 1 illustrates an automated store checkout system 100 according to an example embodiment. The system 100 allows a person, such as a customer 142, to purchase items without having to wait at a checkout counter. For example, the customer 142 can enter a store building 140, provide identification to an identification scanner, pick up items from shelves throughout the store building 140, and leave the store without stopping at a checkout counter. In some example embodiments, the system 100 includes lighting fixtures 102, 104, 106 that may be recessed or otherwise attached to a ceiling structure 108 or another structure of a store 140. For example, the lighting fixture 102 may be located close to a doorway 138 of the store building 140 while other lighting fixtures including the lighting fixtures 104, 106 may be located further inside the store building 140.

In some example embodiments, the system 100 may also include a scanner 110, a central controller 112, and shelf units 114, 116. The shelf unit 114 may include items on several shelves (e.g., a top shelf, a middle shelf, and a bottom shelf) that hold products, such as an item 124, that are for sale. The shelf unit 114 may also include scales at each shelf, such as scales 128, 130 at the top and bottom shelves of the shelf unit 114. The shelf unit 116 may include items on several shelves that hold products, such as an item 126, that are for sale. The shelf unit 116 may also include scales at each shelf, such as a scale 134 at the bottom shelf of the shelf unit 116.

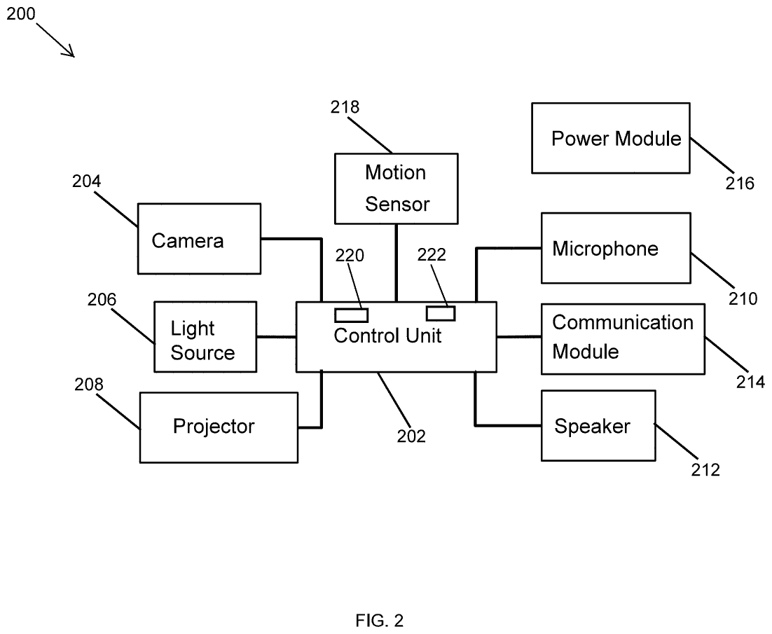

In some example embodiments, the lighting fixtures 102-106, the scanner 110, and the scales of each shelf unit 114, 116 may wirelessly and/or via wired connections communicate with the central controller 112 directly or via a network device such as a router, an access point, and/or a gateway device. For example, the central controller 112 may be a local controller that is at the store building 140 or a remote controller. The central controller 112 may communicate wirelessly or via a wired connection 148. In some example embodiments, the lighting fixtures 102-106, the scanner 110, and the scales of each shelf unit 114, 116 may communicate with each other directly or via a network device. In some example embodiments, the lighting fixtures 102-106 in FIG. 1 may each correspond to a lighting fixture 200 shown in FIG. 2.

FIG. 2 illustrates a block diagram of a lighting fixture used in the automated store checkout system of FIG. 1 according to an example embodiment. Referring to FIGS. 1 and 2, the lighting fixture 200 may include a control unit 202, a camera 204, a light source 206, a projector 208, a microphone 210, a speaker 212, and a communication module 214 that may include one or more transceivers that can be used for wired and/or wireless communication. The lighting fixture 200 may also include a power module 216 that can provide power to the different components of the lighting fixture 200 at suitable power levels. The control unit 202 may send and receive information, commands, etc. via the communication module 214 as can be readily understood by those of ordinary skill in the art with the benefit of this disclosure.

The control unit 202 may control operations of the different components of the lighting fixture 200 and perform analysis of information and data received from the different components. To illustrate, the control unit 202 may control the light source 206 based on lighting control commands received via the communication module 214. The control unit 202 may also control the camera 204, the light source 206, the projector 208, and other components of the lighting fixture 200 based on motion detection information provided by the motion sensor 218. For example, the control unit 202 may power on one or more of the camera 204, the light source 206, and the projector 208 if a motion is detected by the motion sensor 218. As another example, the control unit 202 may power off one or more of the camera 204, the light source 206, and the projector 208 if no motion is detected by the motion sensor 218 for a threshold period (e.g., 5 minutes) of time. The control unit 202 itself may also operate in a low power mode if no motion is detected by the motion sensor 218 for a threshold period. For example, in the low power mode, the control unit 202 may disable or otherwise turn off some of its components and operations.

In some example embodiments, the control unit 202 may perform operations such as image analysis of videos and/or images captured by the camera 204, which may include one or more video and/or still image cameras. For example, the control unit 202 may include a microprocessor 220 that executes executable software code to perform operations described herein with respect the control unit 202. The control unit 202 may also include one or more memory devices 222 for storing data and the executable software code. The control unit 202 may also include other components, such as analog-to-digital converter(s) and digital-to-analog converter(s), that may be used in the operation of the control unit 202.

In some example embodiments, the control unit 202 may perform speech analysis of sounds received by the microphone 210. The control unit 202 may use the speaker 212 to provide responses, notifications, etc. For example, the control unit 202 may process requests received from the customer 142 via the microphone 210 and provide a response to the request via the speaker 212.

In some example embodiments, the control unit 202 may control the light source 206 to provided visual notification, for example, by flashing the light provided by the light source 206, turning on or off the light for a time duration, changing brightness level of the light, emitting a particular color light, etc. The control unit 202 may also control the projector 208 to project information, such as directions, sale items, notifications, etc. on the floor or a wall of the store building 140.

Referring to FIG. 1, in some example embodiments, the scanner 110 may be located close to the doorway 138 of the store building 140 as shown in FIG. 1. For example, the scanner 110 may be activated by a sensor that detects the customer 142 or a customer device such as a customer device 144. The scanner 110 may scan for identification and/or other information from the customer device 144 when the customer device 144 is placed within the scanning range of the scanner 110 by the customer 142. For example, the customer device 144 may be a smartphone displaying a quick response (QR) code or another type of code that includes identification information. In some example embodiments, the information obtained by the scanner 110 from the customer device 144 may include identification information as well as other information, such as a shopping list, product categories, preferences, etc. After scanning identification and other available information from the customer device 144, the scanner 110 may transmit the scanned information to the central controller 112 wirelessly via wireless signals 120 or via a wired connection.

Referring to FIGS. 1 and 2, in some example embodiments, the lighting fixture 102 may capture images of the customer 142 as the customer 142 comes through the doorway 138. The lighting fixture 102 may process the images to determine identifying attributes of the customer 142 and send the identifying attributes to the central controller 212. To illustrate, the lighting fixture 102 may be located such that the customer 142 is in the field of view of the camera 204 of the lighting fixture 102 as the customer 142 passes through the doorway 138 into the store building 140. The camera 204 of the lighting fixture 102 may capture images of the customer 142, and the control unit 202 of the lighting fixture 102 may process the images to identify/determine identifying attributes of the customer 142 that may be used to identify the customer 142 in the store building 140. The controller 202 may send the identifying attributes of the customer 142 to the central controller 212, for example, via the communication module 214. In general, identifying attributes of customers that may be used to identify individual customers in the store building 140 may include color of clothing, hair color, eye glasses, shape of face, etc. The camera 204 may capture images in response to motion detection of the motion sensor 218 or may continuously or periodically capture images.

In some example embodiments, the central controller 112 may receive identification information from the scanner 110 and the identifying attributes from the lighting fixture 102 and associate the two with each other. The central controller 112 may determine that the identification information from the scanner 110 and the identifying attributes from the lighting fixture 102 are related to each other, for example, based on close reception times at the controller 112. The central controller 112 may send a command to the lighting fixture 102 to provide a visual or audio notification to the customer 142 that the identification information was successfully scanned by the scanner 110. To illustrate, the central controller 112 may include a microprocessor, a memory device, a communication module, etc. and may receive, process, and transmit information as can be readily understood by those of ordinary skill in the art with the benefit of this disclosure. The lighting fixture 102 may receive the command from the central controller 112 and may, for example, brighten or flash (e.g., quick flash) the light provided by the light source 206 or may provide an audio message via the speaker 212.

In some example embodiments, if the central controller 112 receives identifying attributes from the lighting fixture 102 but does not receive identification information from the scanner 110, the central controller 112 may send a command to the lighting fixture 102 to provide a visual or audio notification to the customer 142. For example, the lighting fixture 102 may receive the command from the central controller 112 and dim or flash (e.g., slow flash) the light provided by the light source 206. Alternatively or in addition, the lighting fixture 102 may provide an audio message via the speaker 212.

In some example embodiments, if the central controller 112 receives a shopping list or similar information from the scanner 110 along with or related to the identification information obtained from the customer device 144, the central controller 112 may process the information and send a command to the lighting fixture 102 to provide direction information to the customer 142. The lighting fixture 102 may receive the command and, for example, project an arrow 146 on the floor in front of the customer 142 in a direction of an area where the customer 142 can find an item on the shopping list. For example, the controller 202 of the lighting fixture 102 may receive the command via the communication module 214 and project the arrow 146 using the projector 208. In some example embodiments, the lighting fixture 102, using the projector 208, may also project an advertisement and/or other information on the floor in view of the customer 142.

As the customer 142 moves further into the store building 140, the customer 142 comes into the field of view of cameras of one or more other lighting fixtures of the system 100. For example, as the customer 142 walks toward the shelf unit 114 that is within the field of view of the camera 204 of the lighting fixture 104, the camera 204 of the lighting fixture 104 may capture a video or still images of the customer 142. The control unit 202 of the lighting fixture 104 may process the video or the images captured by the camera 204 of the lighting fixture 104 and identify/determine identifying attributes of the customer 142. The lighting fixture 104 may transmit the identifying attributes of the customer 142 to the central controller 112 that may receive and compare the identifying attributes received from the lighting fixture 104 against identifying attributes of customers received from the lighting fixture 102 and any other lighting fixtures. For example, if the central controller 112 determines that the customer 142 as captured by the camera 204 of the lighting fixture 102 and the camera 204 of the lighting fixture 104 is the same person, the central controller 112 may associate the identification information previously received from the scanner 110 with the customer 142 who is now at a location near the shelf unit 114. For example, information associating the lighting fixture 104 with the shelf unit 114 may have been provided to the central controller 112 during or after commissioning of the system 100. As such, the central controller 112 may associate customer activity information received from the shelf unit 114 (e.g., from a scale of the shelf unit 114) and/or the lighting fixture 104 with the identification information of the customer 142.

If the customer 142 did not provide identification information to the scanner 110 such that the identifying attributes of the customer 142 received from the lighting fixture 102 were not associated with the customer 142, the controller 112 may send a command to the lighting fixture 104 to provide a visual and/or audio notification to the customer 142. For example, the lighting fixture 104 may flash or dim a light provided by the light source 206 of the lighting fixture 104. The notification may prompt the customer 142 to return to the scanner 110 and provide the identification information. Alternatively, the notification may prompt the customer 142 to display the identification information to the camera 204 of the lighting fixture 104, which may capture the identification information. The control unit 202 of the lighting fixture 104 may transmit, using the communication module 214, the identification information to the central controller 112, which may associate the identification information with the identifying attributes of the customer 142 received from the lighting fixture 104. Alternatively, the control unit 202 of the lighting fixture 104 may transmit to the controller 112 the identifying attributes of the customer 142 in association with the identification information captured by the camera 204 of the lighting fixture 104.

When the customer 142 engages in a customer activity such as picking up an item from a shelf of the shelf unit 114, the respective scale of the shelf may transmit to the central controller 112 weight information (e.g., current weight measured by the scale) along with an identifier of the shelf unit 114 or an identifier of the particular scale. For example, each scale may include a transmitter to transmit information to the central controller 112 wirelessly or via a wired connection. Because all items on a particular shelf of the shelf unit 114 are the same type of product having practically the same weight, the central controller 112 can determine the number of products the customer 142 has taken from the shelves of the shelf unit 114 based on the change in weight. To illustrate, for each shelf unit 114, 116 or for each shelf of the shelf units 114, 116, the central controller 112 may be programmed with or may access per item weight information. If the customer 142 picks up the item 124, the scale 128, which measures the weight of all items on the top shelf, may transmit to the central controller 112 weight information, for example, via wireless signals 132. Based on the change in weight from the previous or initial weight of items on the top shelf and based on the knowledge of the particular type of product (e.g., a particular size box of cereal), the central controller 112 may determine that the customer 142 has taken an item of the particular product from the shelf unit 114 and record information identifying the item in association with the customer 142. For example, the central controller 112 may record the information in association with the identification information of the person. As the customer 142 takes other items from the shelves of the shelf unit 114, the respective scales transmit weight information to the central controller 112 that records or otherwise keeps track of the items that the customer 142 takes from shelf units in association with the customer 142.

In some example embodiments, if the customer 142 puts back an item on the shelf unit 114, the central controller 112 can keep track of such actions based on the weight information transmitted by the scale of the particular shelf of the shelf unit 114. The central controller 112 can also determine based on the weight information provided by the scale of a particular shelf if the customer 142 puts back an item on the wrong shelf. To illustrate, because items on a particular shelf have generally the same weight, an item that does not belong on a particular shelf causes the total weight to be different from the expected total weight of the items that belong on the shelf. In response to determining that the customer 142 has placed an item on the wrong shelf of the shelf unit 114, the central controller 112 may transmit a command to the lighting fixture 104 to provide a notification to the customer 142. For example, the lighting fixture 104 may provide a visual notification (e.g., flash the light provided by the light source 206) or an audio notification via the speaker 212. The central controller 112 may also send a command to a lighting fixture near a local or remote employee to flash a light provided by the lighting fixture or otherwise provide a visual notification using the light source of the lighting fixture.

In some example embodiments, the customer 142 may ask a question through the lighting fixture 104. For example, the customer 142 may ask where a particular product is located in the store, and the lighting fixture 104 provides a response. For example, the control unit 202 of the lighting fixture 104 may receive the question via the microphone 210 of the lighting fixture 104 and may perform speech analysis to identify/recognize the question. The control unit 202 may then generate a response based on information stored in the lighting fixture 104 and provide an audio response via the speaker 212. Alternatively, the lighting fixture 104 may send the question to the central controller 112 that processes the question and transmits a response to the lighting fixture 104 that may provide an audio response via the speaker 212 of the lighting fixture 104.

As the customer moves to the shelf unit 116 that is associated with the lighting fixture 106 or the camera 204 of the lighting fixture 106, the camera 204 may capture a video or still images of the customer 142, and the control unit 202 of the lighting fixture 106 may process the video or the images to determine identifying attributes of the customer 142. The central controller 112 may receive the identifying attributes from the lighting fixture 106 and compare these identifying attributes against identifying attributes of customers, including the customer 142, received from the lighting fixture 102 and/or other lighting fixtures of the system 100. After determining that the identifying attributes received from the lighting fixture 106 correspond to the customer 142, the central controller 142 may associate customer activities related to the shelf unit 116 with the customer 142 in the same manner as described with respect to the shelf unit 114 and the lighting fixture 104.

Based on the matching of the identifying attributes received from the lighting fixtures, the central controller 112 associates the identification information of the customer 142 obtained from the scanner 110 with customer 142 as the customer moves around the store and comes in view of different cameras of the lighting fixtures of the system 100. As the customer 142 leaves the store building 140 through the doorway 138 (in a similar manner as shown with respect to a customer 150), the lighting fixture 102 or another lighting fixture that is close to the doorway 138 captures and processes a video or still images of the customer 142 as described above to identify the customer 142. Based on the matching of the identifying attributes received from the lighting fixture at the doorway 138 and from other lighting fixtures, such as the lighting fixtures 104, 106, the central controller 112 may determine that the customer 142 has left the store building 142.

Because the physical attributes of the customer 142 that are determined by the control unit 202 of the lighting fixtures 102-106 are associated with the identification information of the customer 142 obtained from the scanner 110, the system 100 can keep track of the items that the customer 142 takes and returns to shelf units 114, 116, etc. When the customer 142 finishes shopping, the customer 142 can simply walk out of the store building 140 without having to wait at a checkout line. Because a person with known information (e.g., name, credit card number, billing address, etc.) is associated with the particular identification information of the customer 142 (e.g., during a registration process to obtain the identification information), the items taken by the customer 142 can be charged to the particular person.

In some example embodiments, the system 100 may include more or fewer lighting fixtures than shown without departing from the scope of this disclosure. In some example embodiments, the system 100 may include more or fewer shelf units than shown without departing from the scope of this disclosure. In some alternative embodiments, the shelf units may have more or fewer shelves than shown with respect to the lighting fixtures without departing from the scope of this disclosure. In some alternative embodiments, the shelf units may be arranged differently than shown with respect to the lighting fixtures without departing from the scope of this disclosure. In some example embodiments, one or more of the lighting fixtures 102-106 may include more or fewer components than shown in FIG. 2 without departing from the scope of this disclosure. For example, one or more of the lighting fixtures 102-106 may not include the projector, the motion sensor, the microphone, and/or the speaker. In some alternative embodiments, one or more of the lighting fixtures 102-106 may be another type of lighting device.

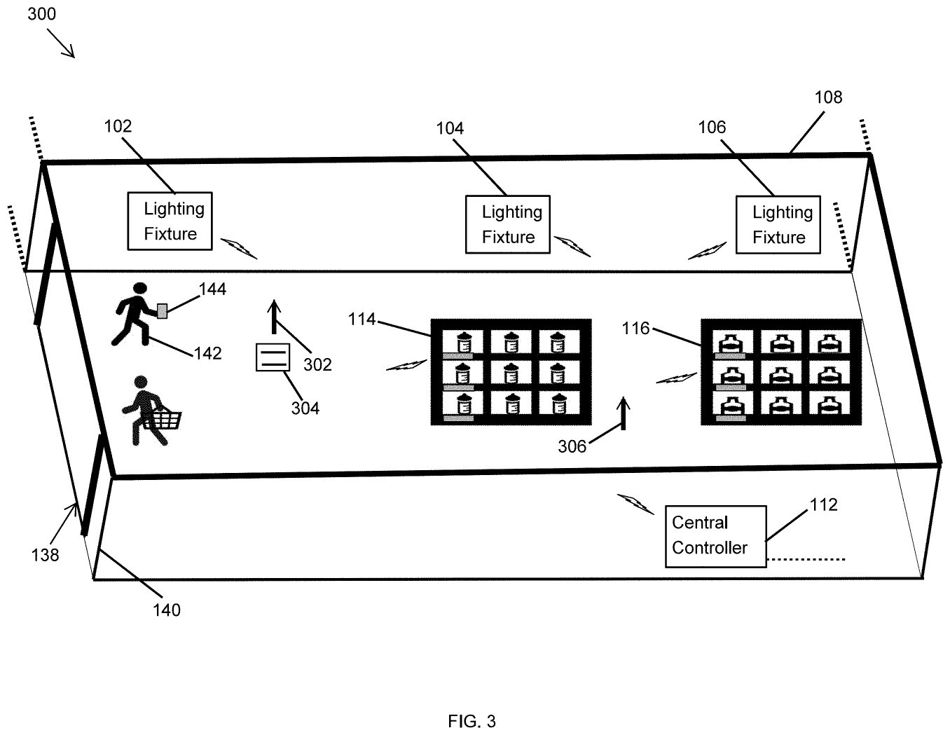

FIG. 3 illustrates an automated store checkout system 300 according to another example embodiment. Referring to FIGS. 1-3, in some example embodiments, the system 300 includes the lighting fixtures 102-106, the central controller 112, and the shelf units 114, 116. The system 300 may operate in substantially the same manner as the system 100 of FIG. 1 to allow the customer 142 to purchase items without having to wait at a checkout counter. For example, the central controller 112 may operate and communicate with the lighting fixtures 102-106 and the scales of the shelf units 114, 116 in a similar manner as described with respect to the system 100. In contrast the system 100, the system 300 does not include the scanner 110. Instead, the camera 204 of the lighting fixture 102, which is close to a doorway 138, may capture a video or images of the identification information of the customer 142 from the customer device 144.

To illustrate, as customer 142 enters the store building 140, the motion sensor 218 of the lighting fixture 102 may detect the customer 142, and the control unit 202 of the lighting fixture 102 may control the camera 204 of the lighting fixture 102 based on the motion detection by the motion sensor 218 to capture a video or one or more images of the customer 142 as well as the identification information of the customer 142. The control unit 202 of the lighting fixture 102 may identify/determine identifying attributes of the customer 142 by processing the captured video or images and send the identification information as well as the identifying attributes to the central controller 112. For example, the control unit 202 of the lighting fixture 102 may send the identifying attributes in association with the identification information. The central controller 112 may send a command to the lighting fixture 102 to provide a visual or audio notification to the customer 142 that the identification information was successfully captured by the camera 204 of the lighting fixture 102.

As the customer 142 moves around the store building 140, the system 300 operates in a similar manner as described with respect to the system 100. For example, if the customer 142 does not provide identification information to the lighting fixture 102 or if the identification information was not successfully captured by the camera 204 of the lighting fixture 102, the central controller 112 may send a command to other lighting fixtures such as the lighting fixtures 104, 106 to provide a visual notification and/or an audio notification to the customer 142 as the customer 142 moves within the field of view of the camera 204 of the respective lighting fixtures. The lighting fixtures 102, 104, 106 may receive the command from the central controller 112 and may responsively, for example, brighten, dim, or flash the light provided by the light source 206 of the respective lighting fixtures 102, 104, 106 as a notification to the customer 142. Alternatively or in addition, the lighting fixtures 102, 104, 106 may provide an audio message via the speaker 212 in response to the command from the central controller 112. The notifications may prompt the customer 142 to provide identification information via the camera 204 of the respective lighting fixture as described with respect to the system 100.

In some example embodiments, the lighting fixture 102 may project an arrow 302 and a product advertisement 304 on the floor in front of the customer 142. For example, the arrow 302 may point in a direction of an area where the customer 142 can find the advertised items. Alternatively or in addition, the lighting fixture 102 may project the arrow 302 in a direction of an area where the customer 142 can find items on the shopping list that was captured by the camera 204 of the lighting fixture 102. For example, the lighting fixture 102 may project the arrow 302 in response to a command from the central controller 112 in a similar manner as described with the system 100. The lighting fixture 104 may project an arrow 306 as the customer 142 gets close to the lighting fixture 104 in a similar manner as described with respect to the lighting fixture 102. In some example embodiments, the lighting fixture 104, using the projector 208, may also project an advertisement and/or other information on the floor in view of the customer 142.

As described above with respect to the system 100, in some example embodiments, the customer 142 may ask a question via the lighting fixtures 102-106. For example, the control unit 202 of the lighting fixture 106 may receive the question via the microphone 210 of the lighting fixture 106 and may perform speech analysis to identify/recognize the question. The control unit 202 may then generate a response based on information stored in the lighting fixture 106 and provide an audio response via the speaker 212 of the lighting fixture 106. Alternatively, the lighting fixture 106 may send the question to the central controller 112 that processes the question and transmits a response to the lighting fixture 106 that may provide an audio response via the speaker 212 of the lighting fixture 106.

In some example embodiments, the system 300 may include more or fewer lighting fixtures than shown without departing from the scope of this disclosure. In some example embodiments, the system 300 may include more or fewer shelf units than shown without departing from the scope of this disclosure. In some alternative embodiments, the shelf units may have more or fewer shelves than shown with respect to the lighting fixtures without departing from the scope of this disclosure. In some alternative embodiments, the shelf units may be arranged differently than shown with respect to the lighting fixtures without departing from the scope of this disclosure. In some example embodiments, one or more of the lighting fixtures 102-106 may not include the projector, the motion sensor, the microphone, and/or the speaker. In some alternative embodiments, one or more of the lighting fixtures 102-106 may be another type of lighting device.

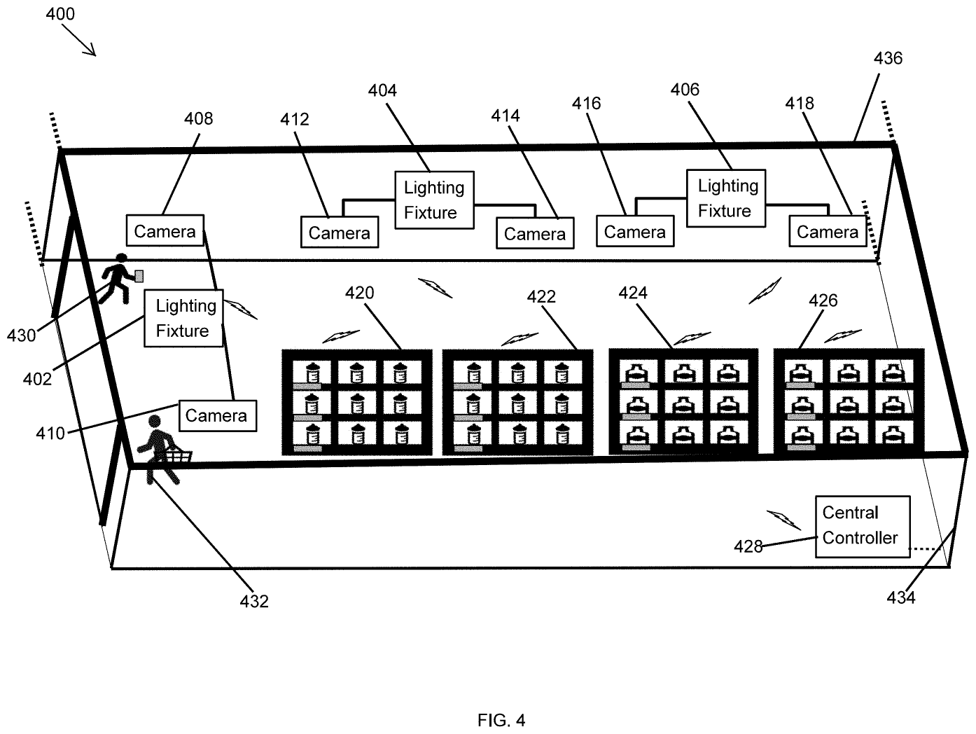

FIG. 4 illustrates an automated store checkout system 400 according to another example embodiment. In some example embodiments, the system 400 may include lighting fixtures 402, 404, 406 that may be recessed or otherwise attached to a ceiling structure 436 of a store building 434. The system 400 may also include a central controller 428 and shelf units 420-426. In general, the system 400 operates in a same manner as the systems 100, 300 to allow a customer 430 to purchase items without having to wait at a checkout counter. In contrast to the lighting fixtures of the systems 100, 300, the lighting fixtures 402-406 may not include a camera. Instead, the system 400 may include cameras that are external to the lighting fixtures 402-406. To illustrate, the system 400 may include cameras 408-418 that are coupled to the lighting fixtures 402-406. For example, the cameras 408, 410 may be coupled to the lighting fixture 402, the cameras 412, 414 may be coupled to the lighting fixture 404, and the cameras 416, 418 may be coupled to the lighting fixture 402.

In some example embodiments, the lighting fixtures 402-406 may process video/images captured by the respective ones of the cameras 408-418 to determine identifying attributes in a similar manner as described with the systems 100, 300. The lighting fixtures 402-406 may transmit information, such as identifying attributes as well as identification information obtained/extracted from one or more images captured by the respective cameras, to the central controller 428 in a similar manner as described with the systems 100, 300. The lighting fixtures 402-406 may also transmit other information such as a shopping list captured by a respective external camera. The lighting fixtures 402-406 may also receive information/commands from the central controller 428 and provide video and/or audio notifications in a similar manner as described with the systems 100 and 300.

In some example embodiments, the central controller 428 may correspond to the central controller 112, and the shelf units 420-426 may be similar to the shelf units 114, 116 described above. For example, the central controller 428 may receive information from the lighting fixtures 402-406, process the information, and transmit commands and information to the lighting fixtures 402-406 in the same manner as described with respect to the central controller 112 of the systems 100, 300. The shelf units 420-426 may include scales that operate in a similar manner as described with respect to the scales of the shelf units of the systems 100, 300. For example, the scales of the shelf units 420-426 may transmit to the central controller 428 the same type of information as described with respect to the systems 100, 300. The lighting fixtures 402-406 and the scales of each shelf unit 420-426 may communicate with the central controller 428 directly or via a network device. The lighting fixtures 402-406 and the scales of each shelf unit 420-426 may communicate with each other directly or via a network device.

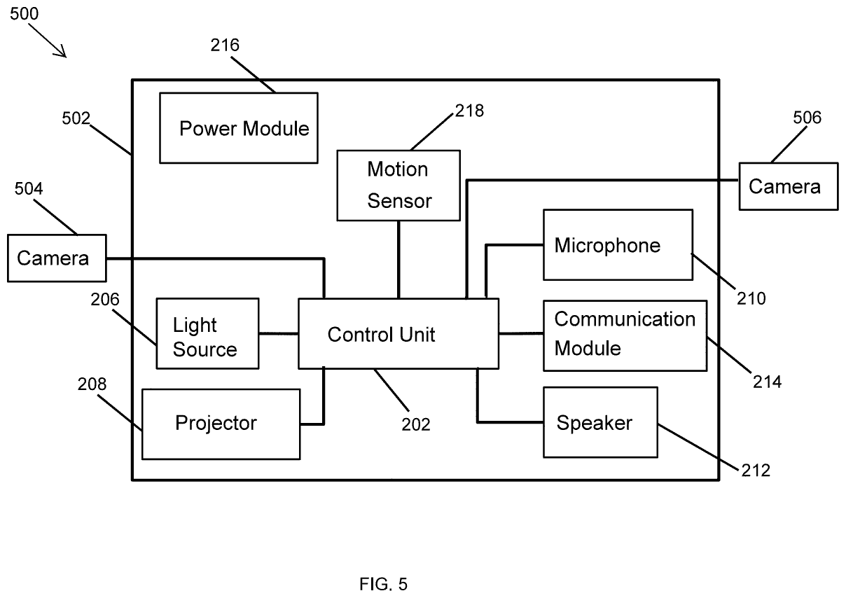

FIG. 5 illustrates a block diagram of a lighting and camera system 500 used in the automated store checkout system 400 of FIG. 4 according to an example embodiment. Referring to FIGS. 4 and 5, in some example embodiments, each lighting fixture 402-406 of the system 400 and the respectively connected cameras may correspond to the lighting and camera system 500.

In some example embodiments, the system 500 includes a lighting fixture 502 and external cameras 504, 506. For example, the lighting fixtures 402-406 of the system 400 may each correspond to a lighting fixture 502 of the system 500. In general, the lighting fixture 502 corresponds to and operates in the same manner as the lighting fixture 200 shown in FIG. 2. To illustrate, the lighting fixture 500 may include the control unit 202, the camera 204, the light source 206, the projector 208, the microphone 210, the speaker 212, and the communication module 214 that may include one or more transceivers that can be used for wired and/or wireless communication. The lighting fixture 500 may also include the power module 216 that can provide power to the different components of the lighting fixture 500 at suitable power levels. The power module 216 may also provide power to the external cameras 504, 506. The control unit 202 may send and receive information, commands, etc. via the communication module 214 as can be readily understood by those of ordinary skill in the art with the benefit of this disclosure.

In contrast to the lighting fixture 200, the lighting fixture 502 may not include the integrated camera 204. To illustrate, the control unit 202 of the lighting fixture 502 may control the cameras 504, 506 and may process video and/or images from both cameras 504, 506 in a similar manner as described with respect to the lighting fixture 200.

To illustrate, as the customer 430 comes into the store building 434, the camera 408 connected to the lighting fixture 402 may capture images of the customer 430 as well as identification information of the customer 430. As the customer 430 leaves the store building 434, the camera 410 connected to the lighting fixture 402 may capture images of the customer 430. The control unit 202 of the lighting fixture 402 may process images captured by the cameras 408, 410 to determine/extract the identification information and/or to identify/determine identifying attributes of the customer 430. The control unit 202 of the lighting fixture 402 may transmit information, such as the identification information and identifying attributes, to the central controller 428 in a similar manner as described with the systems 100 and 300.

In some example embodiments, each camera that is connected to each lighting fixture 404, 406 may be associated with a respective shelf unit. For example, the camera 412 may be associated with the shelf unit 420 such that when images of the customer 430 are captured by the camera 412 and identifying attributes are transmitted to the central controller 428 by the lighting fixture 404, the central controller 428 may attribute customer activities related to items on the shelf unit 420 to the customer 430. A scale of the shelf unit 420 may transmit to the central controller 428 customer activity information that gets associated with the customer 430. For example, the scale of the shelf unit 420 may transmit the customer activity information in association with an identifier of the shelf unit 420 or the scale. Information associating the camera 412 with the shelf unit 420 may be provided to the central controller 428 during or after commissioning of the system 400. For example, the lighting fixture 404 may transmit identifying attributes of the customer 430 to the central controller 428 in association with an identifier of the camera 412. As another example, the camera 414 may be associated with the shelf unit 422 such that when the customer 430 is captured by the camera 414, customer activities related to items on the shelf unit 422 are attributed to the customer 430. Information associating the camera 414 with the shelf unit 422 may have been provided to the central controller 428 during or after commissioning of the system 400.

In some example embodiments, the lighting fixtures 402-406 may project direction indicators (e.g., arrows), advertisement, etc. on the floor of the store building 434 in a similar manner as described with respect to the systems 100, 300. For example, the control unit 202 each lighting fixture 402-406 may control the respective projector 208 to project information, such as directions, sale items, notifications, etc. on the floor or a wall of the store building 140. For example, one or more of the lighting fixtures 402-406 may project an arrow on the floor to point to area where the customer 430 can find an item in a shopping list captured by a respective external camera.

In some example embodiments, the lighting fixtures 402-406 may receive questions/requests via a respective microphone of the lighting fixtures 402-406 and provide responses in a similar manner as described with respect the systems 100, 300. To illustrate, the customer 430 may ask a question via the lighting fixtures 402-406. For example, the control unit 202 of the lighting fixture 402 may receive the question via the microphone 210 of the lighting fixture 402 and may perform speech analysis to identify/recognize the question. The control unit 202 may then generate a response based on information stored in the lighting fixture 402 and provide an audio response via the speaker 212 of the lighting fixture 402. Alternatively, the lighting fixture 402 may send the question to the central controller 428 that processes the question and transmits a response to the lighting fixture 402 that may provide an audio response via the speaker 212 of the lighting fixture 402.

In some example embodiments, the system 400 may include more or fewer lighting fixtures than shown without departing from the scope of this disclosure. In some example embodiments, the system 400 may include more or fewer shelf units than shown without departing from the scope of this disclosure. In some alternative embodiments, the shelf units may have more or fewer shelves than shown with respect to the lighting fixtures without departing from the scope of this disclosure. In some alternative embodiments, the shelf units may be arranged differently than shown with respect to the lighting fixtures without departing from the scope of this disclosure. In some example embodiments, one or more of the lighting fixtures 402-406 may include more or fewer components than shown in FIG. 5 with respect to the lighting fixture 502 without departing from the scope of this disclosure. For example, one or more of the lighting fixtures 402-406 may not include the projector, the motion sensor, the microphone, and/or the speaker. In some alternative embodiments, one or more of the lighting fixtures 402-406 may be coupled to more or fewer than two external cameras without departing from the scope of this disclosure. In some alternative embodiments, the lighting fixtures 402-406 may include one or more integrated cameras in addition to the external cameras without departing from the scope of this disclosure. In some alternative embodiments, In some alternative embodiments, one or more of the lighting fixtures 402-406 may be another type of lighting device.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

What is claimed is:

1. A lighting fixture for use in an automated store checkout system, the lighting fixture comprising:
a light source;
a camera; and
a control unit configured to:
determine identifying attributes of a person from one or more images of the person captured by the camera;
transmit the identifying attributes to a controller; and
provide a notification to the person via the light source based on a command received from the controller, wherein the command is generated based on the identifying attributes.

2. The lighting fixture of claim 1, wherein the control unit is configured to transmit to the controller identification information of the person captured by the camera.

3. The lighting fixture of claim 2, wherein the control unit is configured to transmit the identification information in association with the identifying attributes.

4. The lighting fixture of claim 1, further comprising a motion sensor, wherein the control unit is configured to control the camera to capture the one or more images of the person in response to a motion detection by the motion sensor.

5. The lighting fixture of claim 4, wherein the control unit is configured to power off the camera if no motion is detected by the motion sensor for the threshold period of time.

6. The lighting fixture of claim 1, further comprising a microphone and a speaker, wherein the control unit is configured to receive a request via the microphone and to provide a response to the request via the speaker.

7. The lighting fixture of claim 1, further comprising a projector, wherein the control unit is configured to control the projector to project information on a surface for viewing by the person.

8. The lighting fixture of claim 7, wherein the control unit is configured to control the projector to project the information on the surface based on customer information obtained from the person.

9. The lighting fixture of claim 1, wherein the control unit is configured to provide an audio notification to the person via a speaker of the lighting fixture.

10. The lighting fixture of claim 1, wherein the notification indicates to the person whether the identification information of the person is received by the controller.

11. An automated store checkout system, comprising:
a lighting fixture configured to transmit identifying attributes of a person, wherein the identifying attributes are determined by the lighting fixture based on one or more images of the person captured by a camera; and
a controller configured to:
receive the identifying attributes of the person from the lighting fixture; and
record information related to one or more items removed by the person from a shelf unit at least based on information transmitted by the shelf unit and the identifying attributes of the person, wherein the information is recorded in association with the person.

12. The automated store checkout system of claim 11, wherein the lighting fixture is associated with the shelf unit such that the controller is configured to associate customer activities related to products on the shelf unit with identification information of the person and wherein the identification information of the person is associated with the identifying attributes of the person that are transmitted by the lighting fixture.

13. The automated store checkout system of claim 11, further comprising a scanner to scan identification information from a customer device, wherein the scanner is configured to transmit the identification information to the controller and wherein the controller is configured to associate the identification information with the identifying attributes of the person received from the lighting fixture.

14. The automated store checkout system of claim 13, wherein the scanner is configured to transmit to the controller a shopping list scanned by the scanner from the customer device.

15. The automated store checkout system of claim 11, wherein the lighting fixture is configured to transmit identification information of the person captured by the camera in association with the identifying attributes of the person.

16. The automated store checkout system of claim 11, wherein the camera is external to the lighting fixture.

17. The automated store checkout system of claim 11, further comprising a second lighting fixture configured to transmit to the controller the identifying attributes of the person, wherein the identifying attributes are determined by the second lighting fixture based on second one or more images of the person captured by a second camera.

18. The automated store checkout system of claim 17, wherein the second lighting fixture is associated with a second shelf unit such that the controller is configured to associate customer activities related to products on the second shelf unit with identification information of the person and wherein the identification information of the person is associated with the identifying attributes of the person that are transmitted by the second lighting fixture.

19. An automated store checkout method, comprising:
capturing, by a camera of a lighting fixture, one or more images of a person;
determining, by a control unit of the lighting fixture, identifying attributes of the person from the one or more images of the person;
transmitting, by the control unit of the lighting fixture, the identifying attributes to a central controller; and
recording, by a central controller, items removed from a shelf unit by the person based on the identifying attributes of the person received from a second lighting fixture and customer activity information transmitted by the shelf unit, wherein the second lighting fixture is associated with the shelf unit.

20. The automated store checkout method of claim 19, further comprising:
capturing, by a scanner, identification information of the person; and
transmitting, by the scanner, the identification information to the central controller, wherein the central controller associates the identification information of the person with the identifying attributes of the person.
